(19) United States
(12) Patent Application Publication
(10) Pub. No.: US 2024/0311880 A1
(43) Pub. Date: Sep. 19, 2024

(54) AGGREGATING AND ANALYZING DATA FOR TOURIST COMMODITIES

(71) Applicant: Tourism Review LLC, Jersey City, NJ (US)

(72) Inventor: Jose Antonio Arozarena Artaega, Madrid (ES)

(21) Appl. No.: 18/514,278

(22) Filed: Nov. 20, 2023

Related U.S. Application Data
(60) Provisional application No. 63/489,885, filed on Mar. 13, 2023.

(51) Int. Cl. G06Q 30/0282; G06Q 50/14

(52) U.S. Cl. CPC G06Q 30/0282; G06Q 50/14

(57) ABSTRACT

The disclosure describes retrieving, by a server device, and from each of a plurality of remote services each hosted by a respective third-party server device, review data for one or more tourism commodities. The server device analyzes the review data for a first tourism commodity of the one or more tourism commodities from each of the plurality of remote services to construct aggregated review data for the first tourism commodity. The server device generates a graphical user interface including an identification of the first tourism commodity and the aggregated review data for the first tourism commodity. The server device outputs, for display by a display device, the graphical user interface.

### CROSS-REFERENCE TO RELATED APPLICATIONS

This application claims the benefit of U.S. Provisional Application Ser. No. 63/489,885, filed on Mar. 13, 2023 and entitled “AGGREGATING AND ANALYZING DATA FOR TOURIST COMMODITIES”.

### TECHNICAL FIELD

The disclosure relates to data aggregation, alteration, and presentation.

### BACKGROUND OF THE INVENTION

Modern tourists are becoming increasingly reliant on Internet reviews when traveling. Given the breadth and depth of knowledge available online, tourists typically spend hours upon hours of research looking into accommodations, activities, excursions, and transportation when deciding where to go, when to go there, and how to get there. The network traffic created by users having to navigate to a number of different websites, locating their desired commodities on each site, and comparing the extent of each website's reviews on those commodities is substantial, and the time wasted switching between those websites is daunting. This issue is only compounded by the owners of the tourist commodities, as they must monitor an ever growing number of websites to ensure that they are receiving high marks and enticing these tourists to their businesses.

### SUMMARY OF THE INVENTION

In general, the disclosure describes retrieving, by a server device, and from each of a plurality of remote services each hosted by a respective third-party server device, review data for one or more tourism commodities. The server device analyzes the review data for a first tourism commodity of the one or more tourism commodities from each of the plurality of remote services to construct aggregated review data for the first tourism commodity. The server device generates a graphical user interface including an identification of the first tourism commodity and the aggregated review data for the first tourism commodity. The server device outputs, for display by a display device, the graphical user interface.

The bespoke web-based analytics dashboard has several advantages over traditional methods of collecting and analyzing customer feedback. The system collects reviews from various websites, eliminating the need for businesses to visit multiple sites to collect reviews manually, thereby reducing network traffic and data exchanges over a network the system may be connected to. The system provides a centralized platform for businesses to manage their reviews, reducing the need to log in to multiple review websites, thereby improving the user interface for customers and business owners to view review data for a business and reducing the overall traffic over a network for the system by reducing the amount of data transmitted and received over the network. The system provides real-time monitoring of reviews, allowing businesses to respond quickly to customer feedback. The system may allow businesses to customize their analytics dashboard based on their requirements. The system uses natural language processing techniques to provide meaningful insights to businesses, helping them to make informed decisions to enhance customer experience.

In one example, the disclosure includes a method comprising retrieving, by a server device, and from each of a plurality of remote services each hosted by a respective third-party server device, review data for one or more tourism commodities. The method further comprises analyzing, by the server device, the review data for a first tourism commodity of the one or more tourism commodities from each of the plurality of remote services to construct aggregated review data for the first tourism commodity. The method also includes generating, by the server device, a graphical user interface including an identification of the first tourism commodity and the aggregated review data for the first tourism commodity. The method further comprises outputting, by the server device and for display by a display device, the graphical user interface.

In another example of this disclosure, the disclosure includes a computing device comprising one or more storage components and one or more processors. The one or more processors are configured to retrieve, from each of a plurality of remote services each hosted by a respective third-party server device, review data for one or more tourism commodities. The one or more processors are further configured to analyze the review data for a first tourism commodity of the one or more tourism commodities from each of the plurality of remote services to construct aggregated review data for the first tourism commodity. The one or more processors are also configured to generate a graphical user interface including an identification of the first tourism commodity and the aggregated review data for the first tourism commodity. The one or more processors are further configured to output, for display by a display device, the graphical user interface.

A non-transitory computer-readable storage medium having stored thereon instructions that, when executed, cause one or more processors of a computing device to retrieve, from each of a plurality of remote services each hosted by a respective third-party server device, review data for one or more tourism commodities. The instructions, when executed, further cause the one or more processors of the computing device to analyze the review data for a first tourism commodity of the one or more tourism commodities from each of the plurality of remote services to construct aggregated review data for the first tourism commodity. The instructions, when executed, also cause the one or more processors of the computing device to generate a graphical user interface including an identification of the first tourism commodity and the aggregated review data for the first tourism commodity. The instructions, when executed, further cause the one or more processors of the computing device to output, for display by a display device, the graphical user interface.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a flow diagram illustrating an example method of retrieving review data from outside sources and aggregating that data, in accordance with the techniques described herein.

FIG. 2 is a block diagram illustrating a more detailed example of a computing device configured to perform the techniques described herein.

FIG. 3 is an example user interface including latest reviews from a number of different websites, in accordance with the techniques described herein.

FIG. 4 is an example user interface including a live feed of reviews different websites, in accordance with the techniques described herein.

FIG. 5 is an example user interface including a dashboard of the known reviews, in accordance with the techniques described herein.

FIG. 6 is an example user interface including a list of the third-party websites in an example configuration, in accordance with the techniques described herein.

FIG. 7 is an example user interface including statistics on reviews from different websites, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

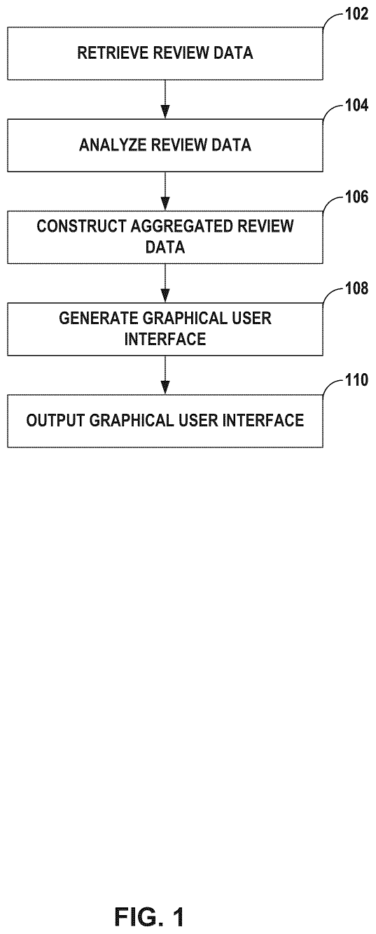

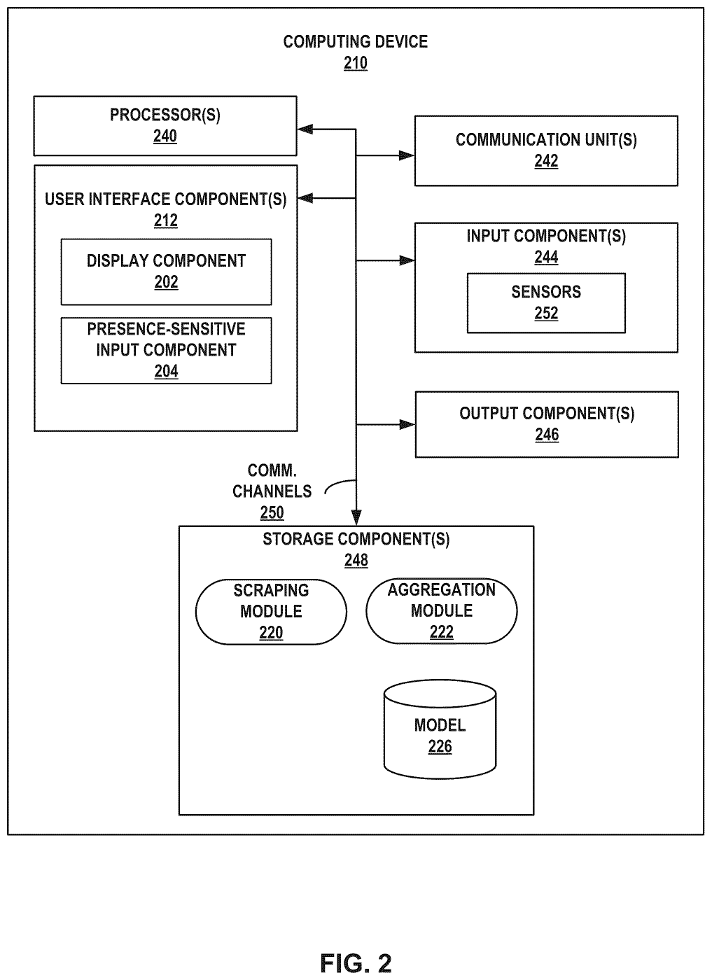

FIG. 1 is a flow chart illustrating an example mode of operation. The techniques of FIG. 1 may be performed by one or more processors of a computing device, such as computing device 210 illustrated in FIG. 2. For purposes of illustration only, the techniques of FIG. 1 are described within the context of computing device 210 of FIG. 2, although computing devices having configurations different than that of computing device 210 may perform the techniques of FIG. 1.

In accordance with the techniques described herein, scraping module 220 may retrieve, from each of a plurality of remote services each hosted by a respective third-party server device, review data for one or more tourism commodities (102). Aggregation module 222 may analyze the review data for a first tourism commodity of the one or more tourism commodities from each of the plurality of remote services (104) to construct aggregated review data for the first tourism commodity (106). Aggregation module 222 may generate a graphical user interface including an identification of the first tourism commodity and the aggregated review data for the first tourism commodity (108). Aggregation module 222 may output, for display by a display device, the graphical user interface (110).

The techniques of this disclosure relate to a web-based analytics dashboard that retrieves reviews from various websites. In the present-day, businesses are looking for ways to collect and analyze reviews to enhance their customer experience. However, gathering reviews from multiple websites can be a daunting task, especially if the businesses have a presence on several review sites.

To address this issue, the present disclosure may provide a bespoke web-based analytics dashboard that can retrieve reviews from various websites and provide insights to businesses to help them improve their customer experience.

The system described herein aggregates reviews from multiple websites and displays them in a single platform. The system is designed to enable businesses to monitor and analyze customer feedback from different sources, such as social media, e-commerce sites, review websites, and other online platforms.

The system's algorithm collects data from various websites, analyzes the data, and may provide meaningful insights to businesses. The analytics dashboard may provide a number of functionalities. A first is the ability to monitor reviews in real-time. The system can collect reviews in real-time, and businesses can monitor their online reputation through the analytics dashboard.

The system may provide the ability to respond to reviews from the centralized dashboard. The system may receive textual replies to reviews from a user, and the system may coordinate sending and posting such responses to the reviews from the particular third-party platform. In this way, the system may provide a centralized platform for businesses to manage their reviews from various websites.

The system may also provide the ability for sentiment analysis. The system uses natural language processing techniques to analyze the sentiment of customer reviews and may provide insights to businesses. For instance, a four- or five-star review without any textual review or with minimal comments may be less beneficial for a business than a four- or five-star review with detailed expressions about particular aspects of the business. The system may detect common pros and cons from the sentiment of the customer reviews and present the common sentiment or analysis regarding the sentiment to the user.

The system may provide for customizable dashboards. The system may allow businesses to customize their analytics dashboard based on their requirements, such as which websites are combed for reviews, what information is shown in the reviews, how the results are sorted, etc.

The system also enables reporting and analysis. The system may provide detailed reports and analysis on customer feedback, enabling businesses to make informed decisions to enhance customer experience. For instance, the system may comb through the reviews and ratings and provide the user with a summary of the analysis, including calculating statistical values (e.g., mean score, median score, standard deviation, etc.) of various ratings or common sentiments amongst the various review platforms.

The system collects data from various websites, including blogs, review-gathering websites, travel guides, and any other website that could include any of the review data described herein with respect to a particular business, including social media platforms. The system uses APIs and data scrapers to retrieve data from these websites.

The system uses services to analyze the customer reviews collected from various websites. The system identifies the sentiment of the reviews, and categorizes them based on the topics discussed in the review.

The system may provide a customizable dashboard that displays the reviews collected from various websites. The dashboard may provide an overview of the reviews, including the sentiment of the reviews, the source of the reviews, and the topics discussed in the reviews. The system also may provide filters and search functionality to enable businesses to search for reviews based on specific criteria.

The system may provide an option (where—for applicable) to respond to reviews submitted at various places.

The system may provide detailed reports and analysis on customer feedback. The reports include charts, graphs, and other visual aids to provide insights to businesses.

The system's algorithm may use machine learning techniques to improve the accuracy of the sentiment analysis and categorization of reviews.

The bespoke web-based analytics dashboard has several advantages over traditional methods of collecting and analyzing customer feedback. The system collects reviews from various websites, eliminating the need for businesses to visit multiple sites to collect reviews manually, thereby reducing network traffic and data exchanges over a network the system may be connected to. The system may provide a centralized platform for businesses to manage their reviews, reducing the need to log in to multiple review websites, thereby improving the user interface for customers and business owners to view review data for a business. The system may provide real-time monitoring of reviews, allowing businesses to respond quickly to customer feedback. The system may allow businesses to customize their analytics dashboard based on their requirements. The system uses natural language processing techniques to provide meaningful insights to businesses, helping them to make informed decisions to enhance customer experience.

The present invention may provide a bespoke web-based analytics dashboard that retrieves reviews from various websites and may provide meaningful insights to businesses. The system uses natural language processing techniques to analyze customer reviews, and the customizable dashboard may provide detailed insights to live reviews.

FIG. 2 is a block diagram illustrating a more detailed example of a computing device configured to perform the techniques described herein. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include scraping module 220, aggregation module 222, and model 226.

One or more processors 240 may implement functionality and/or execute instructions associated with computing device 210 to retrieve data from other sources and aggregate the data locally. That is, processors 240 may implement functionality and/or execute instructions associated with computing device 210 to scrape data from remote review sources and produce an aggregated record in a single graphical user interface.

Examples of processors 240 include any combination of application processors, display controllers, auxiliary processors, one or more sensor hubs, and any other hardware configured to function as a processor, a processing unit, or a processing device, including dedicated graphical processing units (GPUS). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to scrape data from remote review sources and produce an aggregated record in a single graphical user interface.

Scraping module 220 may execute locally (e.g., at processors 240) to provide functions associated with managing data retrieval from third-party review data servers. In some examples, scraping module 220 may act as an interface to a remote service accessible to computing device 210. For example, scraping module 220 may be an interface or application programming interface (API) to a remote server that manages data retrieval from third-party review data servers.

In some examples, aggregation module 222 may execute locally (e.g., at processors 240) to provide functions associated with analyzing the retrieved review data and constructing aggregated data to be output in a graphical user interface. In some examples, aggregation module 222 may act as an interface to a remote service accessible to computing device 210. For example, aggregation module 222 may be an interface or application programming interface (API) to a remote server that analyzes the retrieved review data and constructs aggregated data to be output in a graphical user interface.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and model 226. Storage components 248 may include a memory configured to store data or other information associated with modules 220 and 222 and model 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques described herein, scraping module 220 may retrieve, from each of a plurality of remote services each hosted by a respective third-party server device, review data for one or more tourism commodities. In some instances, in retrieving the review data, scraping module 220 may utilize one or more of an application program interface (API) and a data scraper to retrieve the review data from each of the plurality of remote services. For the purposes of this disclosure, a tourism commodity may be any good, accommodation, or service that could typically be consumed while traveling, such as resorts, hotels, restaurants, excursions, activities, theme parks, land marks, tours, tour guides, museums, or any other business or organization that is typically frequented by those traveling or visiting the area in which that group operates.

Aggregation module 222 may analyze the review data for a first tourism commodity of the one or more tourism commodities from each of the plurality of remote services to construct aggregated review data for the first tourism commodity. In some instances, in analyzing the review data comprises, aggregation module 222 may, for each remote service of the plurality of remote services, extract any numerical ratings included in the review data of the first tourism commodity on the respective remote service. Aggregation module 222 may further determine sentiment data based on any textual information included in the review data of the first tourism commodity on the respective remote service. Aggregation module 222 may also extract any categorical information about the first tourism commodity from the review data of the first tourism commodity on the respective remote service. Aggregation module 222 may construct the aggregated review data using the extracted numerical ratings, the determined sentiment data, and the extracted categorical information. In some instances, aggregating module 222 may utilize model 226, which may be a machine learning model, in analyzing the review data.

In some instances, the sentiment data may include one or more of one or more positive indications, one or more negative indications, and one or more neutral indications included in the textual information.

In some instances, the categorical information may include one or more of goods offered by the first tourism commodity, services offered by the first tourism commodity, topics associated with the first tourism commodity, and descriptive information of the first tourism commodity.

In some instances, the numerical ratings may be one or more of an average rating, each individual rating of a plurality of ratings, a percentage of ratings having a particular numerical value, a total number of ratings, and a number of ratings having the particular numerical value.

In some instances, the aggregated review data may include any one or more of aggregated numerical data across each of the plurality of remote services, sources of each review in the review data, aggregated sentiment data across each of the plurality of remote services, aggregated categorical information about the first tourism commodity from each of the plurality of remote services, a report of the review data, a graph of the review data, a chart of the review data, a visual aid for the review data, and comparisons of the first tourism commodity with a second tourism commodity of the one or more tourism commodities.

Aggregation module 222 may generate a graphical user interface including an identification of the first tourism commodity and the aggregated review data for the first tourism commodity. Aggregation module 222 may output, for display by a display device (e.g., a mobile computing device), the graphical user interface.

In some instances, aggregation module 222 may further receive one or more filtering criteria from a user device. Aggregation module 222 may filter the aggregated review data based on the one or more filtering criteria, updating the graphical user interface to only include the post-filter aggregated review data.

In some instances, aggregation module 222 may further provide a text field in the graphical user interface. Aggregation module 222 may receive an indication of user input indicating a response to the aggregated review data and send the response to the aggregated review data to one of the plurality of remote services.

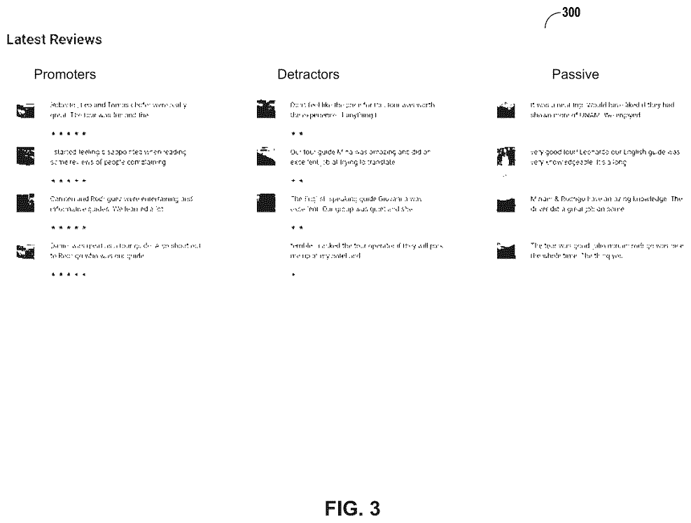

FIG. 3 is an example user interface 300 including latest reviews from a number of different websites, in accordance with the techniques described herein. Interface 300 depicts a simple interface showing the most recent reviews that are positive (e.g., “Promoters”), negative (e.g., “Detractors”), and neutral (e.g., “Passive). In this way, once reviews are retrieved from third-party websites in the manner described throughout this disclosure, the systems and modules described herein may present a user interface that arranges the reviews in an easily monitorable manner, enabling users to quickly see common positive, negative, and neutral feedback across the user's business and across multiple third-party websites without having to individually navigate to each website.

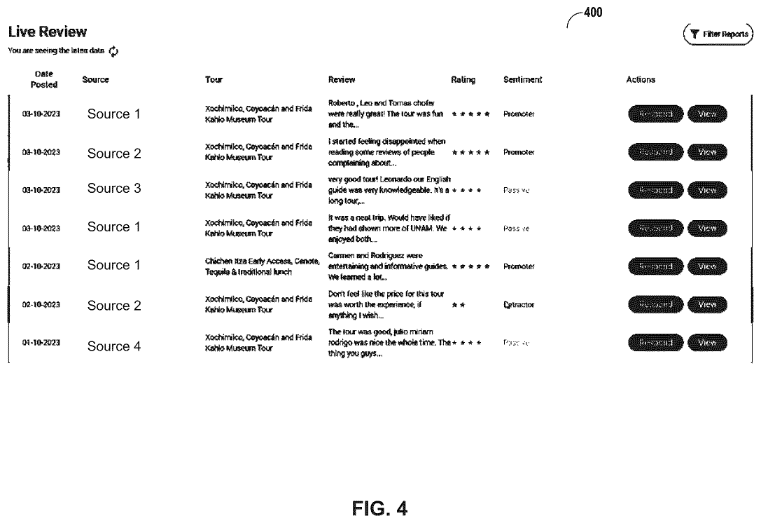

FIG. 4 is an example user interface 400 including a live feed of reviews different websites, in accordance with the techniques described herein. In the example of user interface 400, the seven most recent reviews, regardless of rating or the source, are shown in a single user interface. For instance, user interface 400 includes reviews from four different sources and includes all of positive, negative, and neutral reviews. User interface 400 also includes options for viewing an individual review directly on the third-party website or responding to the review through the dashboard in and of itself. In this way, once reviews are retrieved from third-party websites in the manner described throughout this disclosure, the systems and modules described herein may present a user interface that shows all reviews from third-party websites and provides an quick way of viewing and responding to reviews on the third-party websites without having to individually navigate to each third-party website.

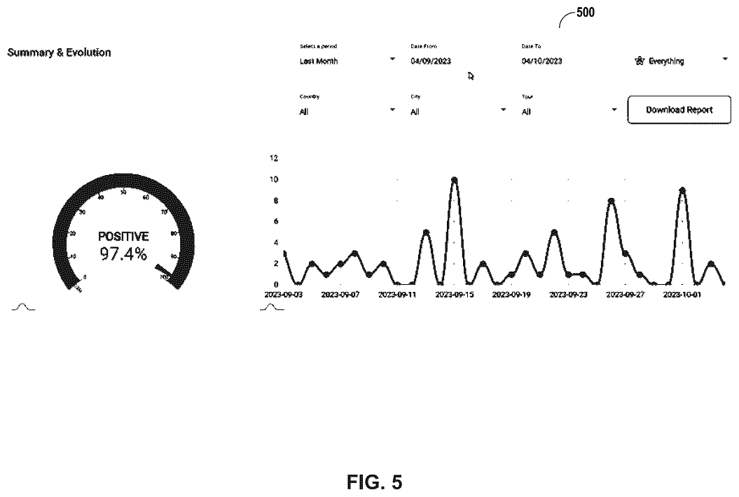

FIG. 5 is an example user interface 500 including a dashboard of the known reviews, in accordance with the techniques described herein. User interface 500 includes a graph depicting quantities of reviews over time, as well as a gauge that shows the percentage of reviews that are positive for a particular user. User interface 500 also provides the user with the ability to filter the reviews across time and location.

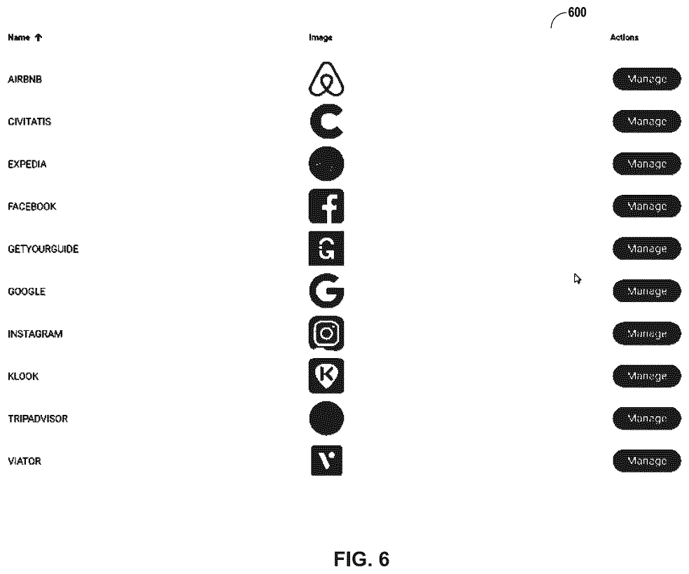

FIG. 6 is an example user interface 600 including a list of the third-party websites in an example configuration, in accordance with the techniques described herein. The techniques described herein may comb through any number of third-party websites to retrieve pertinent reviews for the user's business, including properties and tours. Example third-party entities where the modules and systems described herein may access the reviews held by the third-party entities include AirBnb®, Civitatis®, Expedia®, Facebook®, Get YourGuide®, Google®, Instagram®, Klook®, TripAdvisor®, and Viator®, among other third-party websites. In this way, once reviews are retrieved from third-party websites in the manner described throughout this disclosure, the systems and modules described herein may present a user interface that arranges the reviews in an easily monitorable manner, enabling users to quickly see common positive, negative, and neutral feedback across the user's business and across multiple third-party websites without having to individually navigate to each website.

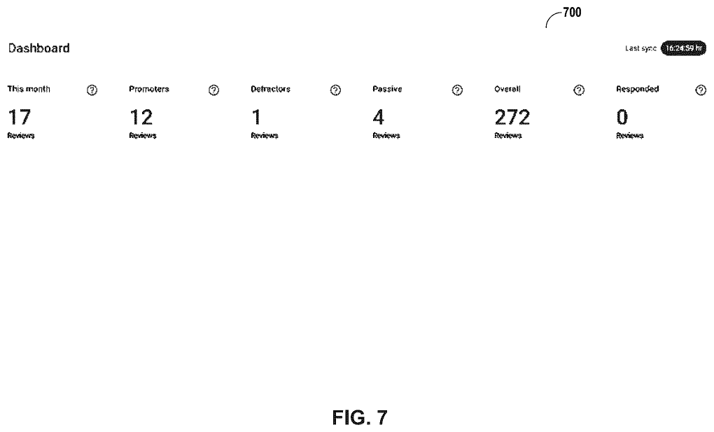

FIG. 7 is an example user interface 700 including statistics on reviews from different websites, in accordance with the techniques described herein. User interface 700 includes a number of statistics, including numbers of reviews received over a certain time period (e.g., this month), how many of those reviews were positive, negative, or passive, a number of reviews received overall regardless of time, and a number of reviews that the user has responded to.

In each of these examples, it is clear that the execution of the techniques described herein improves the functioning of various networks and computer components. Rather than forcing a user to continuously navigate to upwards of 10 or more individual websites that feature their properties or tours and monitor each of those individual third-party websites, the techniques described herein will comb those websites for only the pertinent reviews and updates to those reviews over time, gathering new reviews and updates in a single location reviewable without additional navigation. This reduces the number of internet calls and pings made over the network, thereby reducing network traffic. By also reducing the number of user inputs provided into the system, the durability and longevity of input components into the computer system are also improved.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A method comprising:
retrieving, by a server device, and from each of a plurality of remote services each hosted by a respective third-party server device, review data for one or more tourism commodities;
analyzing, by the server device, the review data for a first tourism commodity of the one or more tourism commodities from each of the plurality of remote services to construct aggregated review data for the first tourism commodity;
generating, by the server device, a graphical user interface including an identification of the first tourism commodity and the aggregated review data for the first tourism commodity; and
outputting, by the server device and for display by a display device, the graphical user interface.

2. The method of claim 1, wherein analyzing the review data comprises:
for each remote service of the plurality of remote services:
extracting, by the server device, any numerical ratings included in the review data of the first tourism commodity on the respective remote service;
determining, by the server device, sentiment data based on any textual information included in the review data of the first tourism commodity on the respective remote service; and
extracting, by the server device, any categorical information about the first tourism commodity from the review data of the first tourism commodity on the respective remote service; and
constructing, by the server device, the aggregated review data using the extracted numerical ratings, the determined sentiment data, and the extracted categorical information.

3. The method of claim 2, wherein the sentiment data comprises one or more of one or more positive indications, one or more negative indications, and one or more neutral indications included in the textual information.

4. The method of claim 2, wherein analyzing the review data further comprises utilizing, by the server device, a machine learning model to analyze the review data.

5. The method of claim 2, wherein the categorical information comprises one or more of goods offered by the first tourism commodity, services offered by the first tourism commodity, topics associated with the first tourism commodity, and descriptive information of the first tourism commodity.

6. The method of claim 2, wherein the numerical ratings comprise one or more of an average rating, each individual rating of a plurality of ratings, a percentage of ratings having a particular numerical value, a total number of ratings, and a number of ratings having the particular numerical value.

7. The method of claim 1, wherein retrieving the review data comprises utilizing, by the server device, one or more of an application program interface (API) and a data scraper to retrieve the review data from each of the plurality of remote services.

8. The method of claim 1, wherein the aggregated review data comprises one or more of:
aggregated numerical data across each of the plurality of remote services,
sources of each review in the review data,
aggregated sentiment data across each of the plurality of remote services,
aggregated categorical information about the first tourism commodity from each of the plurality of remote services,
a report of the review data,
a graph of the review data,
a chart of the review data,
a visual aid for the review data, and
comparisons of the first tourism commodity with a second tourism commodity of the one or more tourism commodities.

9. The method of claim 1, further comprising:
receiving, by the server data, one or more filtering criteria from a user device; and
filtering, by the server data, the aggregated review data based on the one or more filtering criteria.

10. The method of claim 1, further comprising:
providing, by the server device, a text field in the graphical user interface;
receiving, by the server device, an indication of user input indicating a response to the aggregated review data; and
sending, by the server device, the response to the aggregated review data to one of the plurality of remote services.

11. A computing device comprising:
one or more storage components; and
one or more processors configured to:
retrieve, from each of a plurality of remote services each hosted by a respective third-party server device, review data for one or more tourism commodities;
analyze the review data for a first tourism commodity of the one or more tourism commodities from each of the plurality of remote services to construct aggregated review data for the first tourism commodity;
generate a graphical user interface including an identification of the first tourism commodity and the aggregated review data for the first tourism commodity; and
output, for display by a display device, the graphical user interface.

12. The computing device of claim 11, wherein the one or more processors being configured to analyze the review data comprises the one or more processors being configured to:
for each remote service of the plurality of remote services:
extract any numerical ratings included in the review data of the first tourism commodity on the respective remote service;
determine sentiment data based on any textual information included in the review data of the first tourism commodity on the respective remote service; and
extract any categorical information about the first tourism commodity from the review data of the first tourism commodity on the respective remote service; and
construct the aggregated review data using the extracted numerical ratings, the determined sentiment data, and the extracted categorical information.

13. The computing device of claim 12, wherein the sentiment data comprises one or more of one or more positive indications, one or more negative indications, and one or more neutral indications included in the textual information.

14. The computing device of claim 12, wherein the one or more processors being configured to analyze the review data further comprises the one or more processors being configured to utilize a machine learning model to analyze the review data.

15. The computing device of claim 12, wherein the categorical information comprises one or more of goods offered by the first tourism commodity, services offered by the first tourism commodity, topics associated with the first tourism commodity, and descriptive information of the first tourism commodity, and
wherein the numerical ratings comprise one or more of an average rating, each individual rating of a plurality of ratings, a percentage of ratings having a particular numerical value, a total number of ratings, and a number of ratings having the particular numerical value.

16. The computing device of claim 11, wherein retrieving the review data comprises utilizing, by the server device, one or more of an application program interface (API) and a data scraper to retrieve the review data from each of the plurality of remote services.

17. The computing device of claim 11, wherein the aggregated review data comprises one or more of:
aggregated numerical data across each of the plurality of remote services,
sources of each review in the review data,
aggregated sentiment data across each of the plurality of remote services,
aggregated categorical information about the first tourism commodity from each of the plurality of remote services,
a report of the review data,
a graph of the review data,
a chart of the review data,
a visual aid for the review data, and
comparisons of the first tourism commodity with a second tourism commodity of the one or more tourism commodities.

18. The computing device of claim 11, wherein the one or more processors are configured to:
receive one or more filtering criteria from a user device; and
filter the aggregated review data based on the one or more filtering criteria.

19. The computing device of claim 11, wherein the one or more processors are configured to:
provide a text field in the graphical user interface;
receive an indication of user input indicating a response to the aggregated review data; and
send the response to the aggregated review data to one of the plurality of remote services.

20. A non-transitory computer-readable storage medium having stored thereon instructions that, when executed, cause one or more processors of a computing device to:
retrieve, from each of a plurality of remote services each hosted by a respective third-party server device, review data for one or more tourism commodities;
analyze the review data for a first tourism commodity of the one or more tourism commodities from each of the plurality of remote services to construct aggregated review data for the first tourism commodity;
generate a graphical user interface including an identification of the first tourism commodity and the aggregated review data for the first tourism commodity; and
output, for display by a display device, the graphical user interface.
